(19) United States
(12) Patent Application Publication
(10) Pub. No.: US 2006/0246327 A1
(43) Pub. Date: Nov. 2, 2006

(54) Method for maintaining an aqueous solution of sodium borate in a liquid form at room temperature

(76) Inventors: Jean-Francosi Ranjard, Versailles (FR); Xavier Glipa, Bures-Sur-Yvette (FR)

Correspondence Address: NICOLAS E. SECKEL;Patent Attorney, 1250 Connecticut Avenue, NW Suite 700, WASHINGTON, DC, 20036, US

(21) Appl. No.: 10/562,414

(22) PCT Filed: Sep. 13, 2004
(86) PCT No.: PCT/FR04/02321

§ 371 Date: Dec. 23, 2005

(30) Foreign Application Priority Data
Sep. 16, 2003 (FR) 0310871
Sep. 26, 2003 (FR) 0311329

(51) Int. Cl. H01M 8/06; C01B 3/08; G05D 23/00

(52) U.S. Cl. 429/17; 423/657; 236/1 R

(57) ABSTRACT

A method of keeping an aqueous solution of sodium borate liquid at a storage temperature, in which method, in order to pass said solution from an initial temperature to the storage temperature, said aqueous solution of sodium borate is subjected to heat treatment comprising at least one cooling or heating operation at a speed lying in the range 1° C./min to 100° C./min, to reach a holding temperature lying in the range −50° C. to +200° C., followed by holding the holding temperature for a time lying in the range 1 s to 100 h, followed by cooling or heating at a speed lying in the range 1° C./min to 100° C./min. Use of the method in a method of supplying hydrogen for a fuel cell.

The present invention relates to the treatment of an aqueous solution of sodium borate that results from producing hydrogen by decomposing sodium borohydride, where the hydrogen is intended for a variety of applications, and in particular for feeding a fuel cell in a motor vehicle.

For a variety of reasons, such as seeking energy independence, reducing pollution, reducing the emission of greenhouse gases, or in order to economize hydrocarbon resources, attempts are being made to develop methods of producing energy from hydrogen. Such methods rely in particular on using fuel cells in which hydrogen reacts with an oxygen-containing gas, thereby producing electricity.

Any development of such techniques relies on effective and safe techniques being developed for storing hydrogen. For example it is known to store hydrogen in the form of a compressed gas, and it is also known to store hydrogen in the form of a liquefied gas. But neither of those techniques completely satisfies the constraints of the automobile industry, in particular, even though it is seeking to be able to fit vehicles with fuel cells that are powered with hydrogen. Storing gas in the form of a compressed gas is very bulky and can lead to problems of safety because of the high pressures used. Liquid storage also leads to drawbacks, firstly because liquefying gas requires a large amount of energy to be used, and secondly because handling liquid hydrogen at extremely low temperatures involves risks that make it difficult to apply liquid hydrogen to the automobile industry.

The problem of producing and storing hydrogen under conditions of satisfactory safety also arises in other fields of application for hydrogen, for example in the medical field, in the agrifood business, or in various heat treatments.

In order to remedy those drawbacks, proposals have been made to store hydrogen in motor vehicles in the form of sodium borohydride, and to produce hydrogen on demand by decomposing the sodium borohydride by reaction with water to produce firstly hydrogen and secondly a residue constituted by an aqueous solution of sodium borate. That technique has the advantage of enabling hydrogen to be stored in a manner that is safe and of producing hydrogen in a manner that is convenient for feeding to a motor vehicle fuel cell, however it suffers from a drawback. The aqueous solution of sodium borate is recovered and stored in a tank which needs to be emptied regularly. Unfortunately, the sodium borate solution which is liquid at the temperature at which water reacts with sodium borohydride (in the range 100° C. to 180° C.), tends to crystallize on cooling down to ambient temperature, thus making it difficult to empty the sodium borate tank.

The object of the present invention is to remedy that drawback by proposing means for conserving sodium borate solution derived from hydrogen production by decomposing sodium borohydride liquid at ambient temperature.

To this end, the invention provides a method of keeping an aqueous solution of sodium borate liquid at a storage temperature, in which method, in order to pass said solution from an initial temperature to the storage temperature, said aqueous solution of sodium borate is subjected to heat treatment comprising at least one cooling or heating operation at a speed lying in the range 1° C. per minute (° C./min) to 100° C./min, to reach a holding temperature lying in the range −50° C. to +200° C., followed by holding the holding temperature for a time lying in the range 1 second (s) to 100 hours (h), followed by cooling or heating at a speed lying in the range 1° C./min to 100° C./min.

Preferably, the heat treatment includes at least two holding operations at different holding temperatures.

Prior to performing the heat treatment, the aqueous solution of sodium borate is at an initial temperature lying in the range 100° C. to 180° C., and after the heat treatment has been performed, the aqueous solution of sodium borate is at a storage temperature lying in the range −50° C. to +300° C., and preferably in the range −20° C. to +50° C.

Preferably, the aqueous solution of sodium borate contains 5% to 65% by weight of sodium borate and may also contain 0% to 10% by weight of soda.

The invention also relates to a method of generating hydrogen in which sodium borohydride is caused to react with water, and there are separated out therefrom firstly a mixture constituted mainly by hydrogen, and secondly an aqueous solution of sodium borate, in which the aqueous solution of sodium borate is subjected to the heat treatment of the invention.

The method can be used for feeding a fuel cell with hydrogen.

The fuel cell is preferably the fuel cell of a motor vehicle.

The method can also be used for generating hydrogen used in particular in medicine, in the agrifood business, in electronic component fabrication, or in performing heat treatments on metal products.

The invention is described below in greater detail in non-limiting manner and as illustrated by an example.

In novel and unexpected manner, the inventors have found that an aqueous solution of sodium borate derived from the method of producing hydrogen by catalytic decomposition of an aqueous solution of sodium borohydride and containing a small fraction of soda retains its fluidity even when subjected to heat treatment consisting in a string of sequences of cooling and/or heating separated by holding at temperature levels. The cooling or heating operations need to be performed at heating or cooling speeds lying in the range 1° C./min to 100° C./min, and preferably less than 50° C./min, and better still less than 20° C./min. The temperatures of the levels that are held must lie in the range −50° C. to +200° C., and the length of time for which these levels are held must lie in the range 1 s to 100 h, preferably in the range 10 s to 100 h, more preferably in the range 10 s to 50 h, and better still in the range 30 s to 2 h. The cooling or heating speeds, the temperature levels, the durations of the levels, and the order in which sequences are performed all constitute parameters that enable the method to be controlled. The method is used for taking an aqueous solution of sodium borate produced at an initial temperature and bringing it to a storage temperature. The storage temperature lies in the range −50° C. to +300° C., and preferably in the range −20° C. to +50° C. These preferred temperatures correspond to the temperatures that can occur in a tank of a motor vehicle that remains outside, depending on the season and the location.

By way of example, the following treatment has been performed on an aqueous solution of sodium borate that was obtained by producing hydrogen by decomposing sodium borohydride by reaction with water so as to feed a fuel cell with hydrogen:

the aqueous solution of sodium borate was at a temperature of 135° C. at the outlet from the reactor for decomposing sodium borohydride;

the solution was initially cooled down to a temperature of 80° C. at a speed of 5° C./min;

the aqueous solution of sodium borate was held at a temperature of 80° C. for 12 h;

then the aqueous solution of sodium borate was cooled down to a temperature of 60° C. at a speed of 5° C./min;

the aqueous solution of sodium borate was then held at the temperature of 60° C. for 8 h;

then the aqueous solution of sodium borate was cooled to a temperature of 40° C. at a speed of 5° C./min;

the solution of sodium borate was then held at the temperature of 40° C. for 15 h; and finally

the aqueous solution of sodium borate was brought to ambient temperature, i.e. about 20° C., at a speed of about 5° C./min.

Following that heat treatment, the aqueous solution of sodium borate did not present any crystallization and remained in the form of a viscous liquid. The solution obtained in that way was easy to handle and could be extracted from the tank for storing the aqueous solution of sodium borate without any difficulty.

The method is particularly adapted to treating the aqueous solution of sodium borate that results from the method of producing hydrogen for a variety of uses and more particularly for feeding on demand the fuel cell of a motor vehicle.

In a motor vehicle including a fuel cell fed with hydrogen by decomposing sodium borohydride, the sodium borohydride is stored in the form of a liquid solution in a tank. That solution has a concentration by weight of sodium borohydride lying in the range 5% to 35%, and preferably in the range 15% to 25%. The solution may further include a content lying in the range 0% to 10% by weight of soda and preferably 0.5% to 4% that is added to stabilize the aqueous solution of sodium borohydride. Although such an addition is the usual practice, it is not essential. When the vehicle requires electricity to be produced, the sodium borohydride in aqueous solution is taken from the fuel tank and sent to a catalytic reactor where it is decomposed by being reacted with water, thereby producing both hydrogen and sodium borate. The reaction takes place at a temperature lying in the range 100° C. to 180° C. and preferably above 110° C. and better above 130° C., but below 150° C. and better below 140° C. The reaction product is then sent to a gas/liquid separator which separates the gaseous hydrogen, possibly mixed with water vapor, from an aqueous solution that contains mainly sodium borate and that is at a temperature likewise in the range 100° C. to 180° C., preferably in the range 110° C. to 150° C., and better in the range 130° C. to 140° C.

In accordance with the method of the present invention, the aqueous solution of sodium borate also contains a little soda, and it is brought to the storage temperature by heat treatment consisting in a successive of heating or cooling operations separated by being held at level temperatures, as described. At the end of the heat treatment, the aqueous solution of sodium borate is sent to a storage tank in which it remains liquid until it has been emptied out.

As mentioned above, the method can be used in any installation for producing hydrogen by decomposing sodium borohydride, regardless of the use intended for the hydrogen that is produced in this way.

1. A method of keeping an aqueous solution of sodium borate liquid at a storage temperature, in which method, in order to pass said solution from an initial temperature to the storage temperature, said aqueous solution of sodium borate is subjected to heat treatment comprising at least one cooling or heating operation at a speed lying in the range 1° C./min to 100° C./min, to reach a holding temperature lying in the range −50° C. to +200° C., followed by holding the holding temperature for a time lying in the range 1 s to 100 h, followed by cooling or heating at a speed lying in the range 1° C./min to 100° C./min.

2. A method according to claim 1, wherein the heat treatment includes at least two holding operations at different holding temperatures.

3. A method according to claim 1 or claim 2, wherein, prior to performing the heat treatment, the aqueous solution of sodium borate is at an initial temperature lying in the range 100° C. to 180° C., and after performing the heat treatment, the aqueous solution of sodium borate is at a storage temperature lying in the range −50° C. to +300° C.

4. A method according to claim 3, wherein the storage treatment lies in the range −20° C. to +50° C.

5. A method according to claim 1, wherein the aqueous solution of sodium borate contains 5% to 65% by weight of sodium borate.

6. A method according to claim 5, wherein the aqueous solution of sodium borate further contains 0% to 10% by weight of soda.

7. A method of generating hydrogen in which sodium borohydride is caused to react with water and both a gaseous mixture constituted mainly of hydrogen and an aqueous solution of sodium borate are extracted therefrom, wherein the aqueous solution of sodium borate is subjected to the method according to claim 1.

8. The use of the method of claim 7, comprising feeding hydrogen to a fuel cell.

9. The method of claim 8, wherein the fuel cell is the fuel cell of a motor vehicle.

10. The method according to claim 7 wherein the hydrogen is used in medicine, in the agrifood industry, in the fabrication of electronic components, and/or in the implementation of heat treatments on metal products.
